(19) United States
(12) Patent Application Publication
(10) Pub. No.: US 2006/0173757 A1
(43) Pub. Date: Aug. 3, 2006

(54) Method of describing components and building a bicycle

(75) Inventors: John Thayer, Bloomington, MN (US); Annette Webb, Eagan, MN (US); Erik Smeby, Savage, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Quality Bicycle Products, Inc.

(21) Appl. No.: 11/047,812

(22) Filed: Feb. 1, 2005

(51) Int. Cl. G06F 17/60

(52) U.S. Cl. 705/29

(57) ABSTRACT

A method of identifying components and building a bicycle is provided. Methods and products described provides component characteristics, compatibility attributes, and optionally multiple functionality of components in a single component database record. Methods and products described also provide adjustability of component lists for bike building as components are selected. Methods and products described also provide simplification of data entry as new products are added to the database.

### TECHNICAL FIELD

This application relates to database storage of records for components, and methods for assembling equipment from the components. Specifically, this application relates to a method of identifying bicycle components in a database, and a method of identifying components to assemble a bicycle.

### BACKGROUND

There are currently several thousands of bicycle components to select from when assembling a bicycle. Selecting components to assemble a bicycle, or sub assembly of a bicycle, can be difficult due to problems such as compatibility requirements between components. An example bicycle requires approximately 20 to 30 individual components. A computerized method is desired to prompt a user to select one component from a list for each of the 20 to 30 components and thus build a bicycle.

However, computerized methods have a number of obstacles to overcome. It is difficult to provide a user with component choices of what is needed for all types of bicycles and all combinations of components. There are several types of bicycles that can be built, each requiring different numbers of components, and types of components. For example, a single-speed bike doesn't have derailleurs or shift levers, but a road racing bike does. Also, when choosing integrated shift levers a bike doesn't need brake levers. So knowing what is needed changes with bicycle type, and also changes with component substitutions.

One computerized approach has been a static category bike concept. This concept lists all of the needed categories for building a complete bike at the beginning, with no adaptation. A drawback of this approach is that different types of bike templates are needed to prompt a user for each bike variation (i.e. single speed, racing bike, mountain bike, etc.).

Another approach has been a dynamic category bike concept. This concept starts with a frame and builds out. For example when you start with a frame, rules are specified that indicate a frame is attached to a bottom bracket. When a bottom bracket is added rules are specified that indicate a bottom bracket is attached to a crank. Finally, a crank is attached to pedals. Component requirements are determined dynamically based on the parts chosen. Rules determine that a bike must be complete when no components rules indicate further attachments.

Static category bikes have an advantage that a person can configure a crank before a bottom bracket. All component options can be seen from the very beginning of the substitution process. One disadvantage is that hybrid parts such as integrated shifters (shifter+brake) and situations where adapters are used or needed (geared to single-speed adapters, seat post shims, braze-on adapters, etc.) cause the needed categories to increase or decrease. This becomes very unwieldy without adaptation, as large numbers of possible templates are needed. For example, a separate template would be needed for a racing bike with integrated shift levers, and a racing bike with shift levers and brake levers.

Dynamic category bikes have an advantage of building bikes with hybrid parts, however the rules require that component selection begins with a frame. It is not always intuitive to build a bike from the frame out. For example, a handlebar cannot be chosen until a stem is chosen. Another disadvantage includes an inability to see stock status on handlebars (for example) until you have chosen a stem.

What is needed is an improved method of identifying bicycle components in a database to include information that is more useful to the bike building process. What is also needed is an improved method of selecting components to build a bike, or a sub assembly of a bike.

### BRIEF DESCRIPTION OF THE DRAWINGS

FIG. 1A shows a database record of a bicycle component according to an embodiment of the invention.

FIG. 1B shows another database record of a bicycle component according to an embodiment of the invention.

FIG. 2 shows an example component according to an embodiment of the invention.

FIG. 3 shows an adapter component according to an embodiment of the invention.

FIG. 4 shows another adapter component according to an embodiment of the invention.

FIG. 5 shows another example component according to an embodiment of the invention.

FIG. 6 shows a user interface for entering an attribute into a database record according to an embodiment of the invention.

FIG. 7A shows a flow diagram according to an embodiment of the invention.

FIG. 7B shows a screen shot of a software user interface according to an embodiment of the invention.

FIG. 8 shows a diagram of a network system according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, electrical, logical changes, etc. may be made without departing from the scope of the present invention.

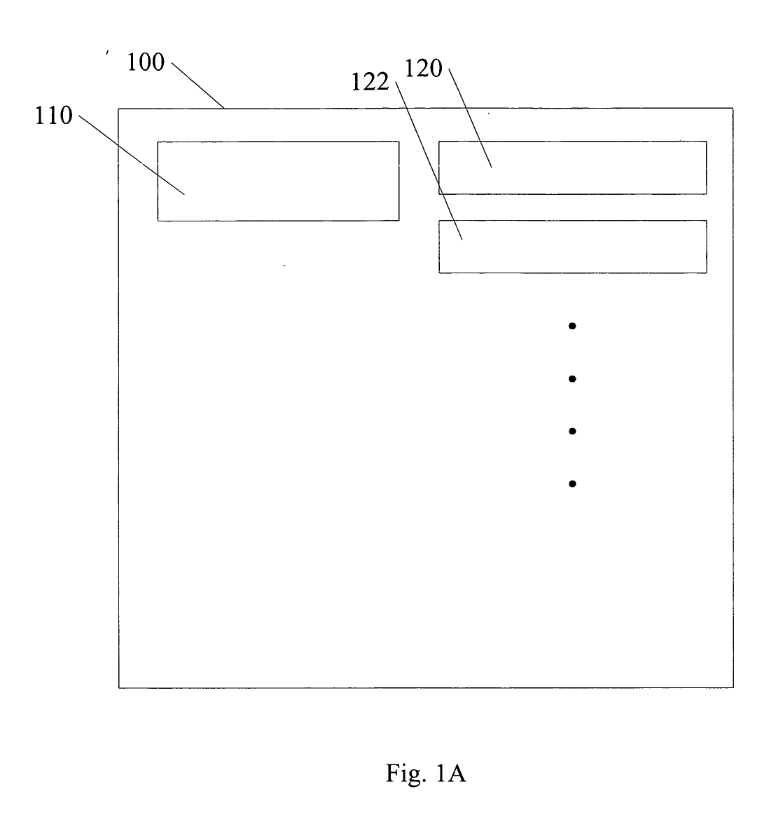

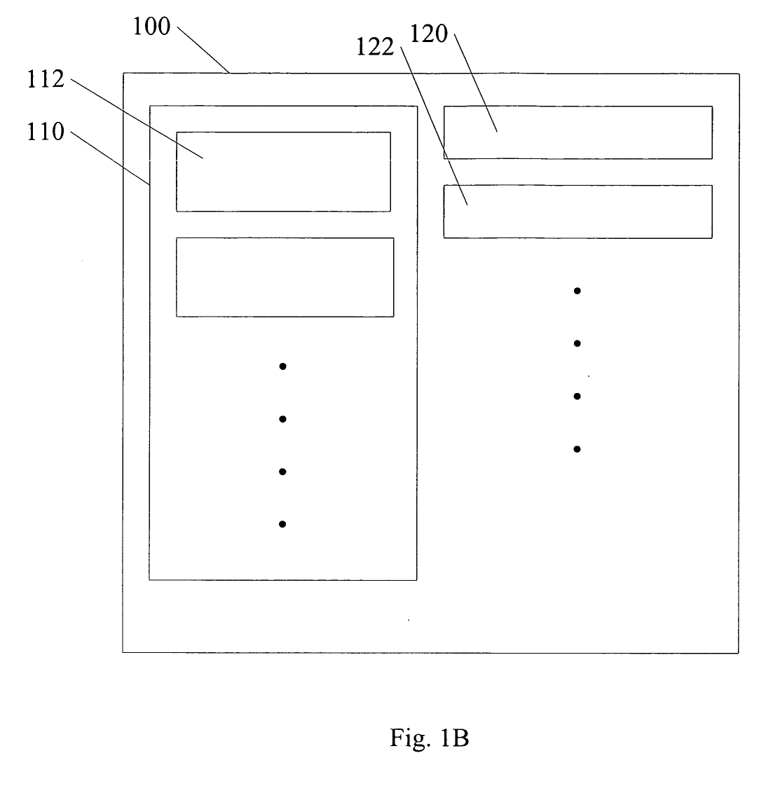

FIG. 1A shows a block diagram of a database record 100 for a bicycle component. A component category 110 is shown in block diagram format. A first attribute 120 and a second attribute 122 are also shown stored in the single database record 100 for the single bicycle component. Although a first attribute 120 and a second attribute 122 are shown in FIG. 1, other embodiments include greater or lower numbers of attributes. Examples of component categories include, but are not limited to, frame, fork, handlebar, stem, aerobar, etc.

FIG. 1B shows a block diagram of the database record 100 according to an embodiment of the invention. The first attribute 120 and the second attribute 122 are shown stored in the single database record 100 for the single bicycle component similar to the diagram shown in FIG. 1A. The component category 110 is also shown in block diagram format in FIG. 1B. In one embodiment, the component category 110 of FIG. 1B is a complex category. In one embodiment, the complex category 110 includes a number of normal categories 112 associated with the single complex category 110. In this example, the single database record 100 includes information indicating the component's classification in a single complex category 110 and in multiple normal categories 112.

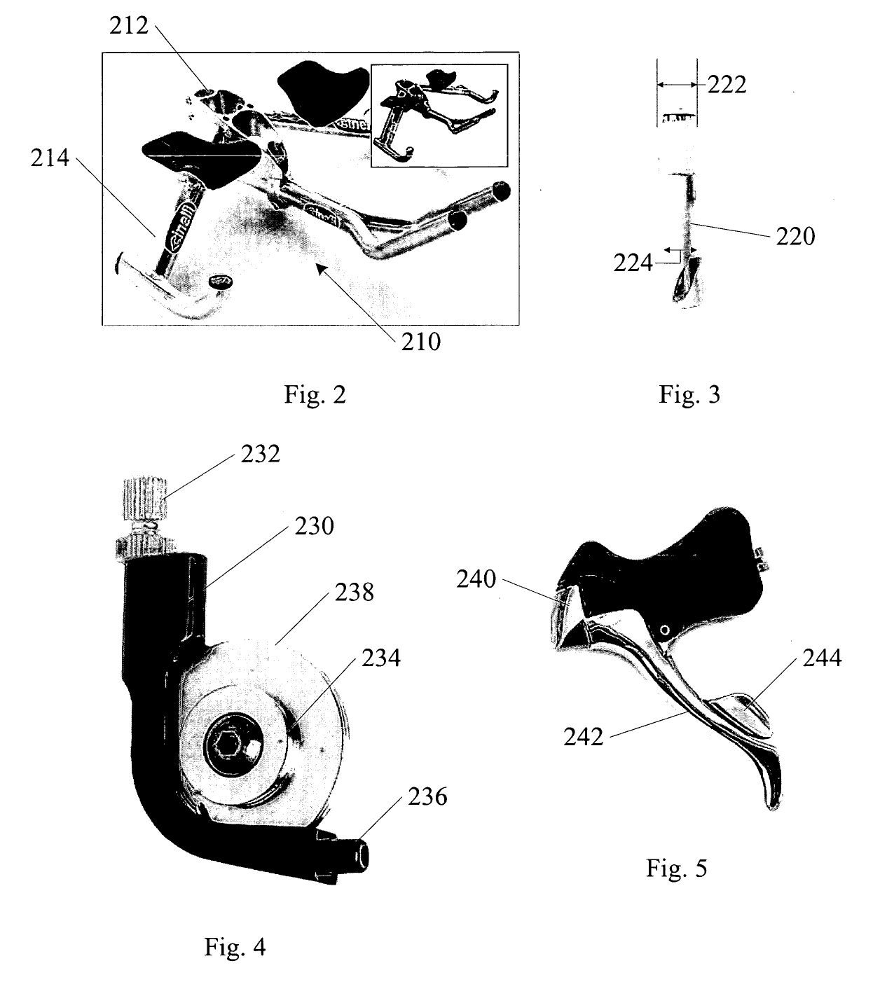

For example, FIG. 2 shows an integrated stem and handlebar 210. A fork attachment portion 212 is shown that is integrally formed with a handlebar portion 214. In one embodiment, the integrated stem and handlebar 210 is recorded with a single record in a database as a complex category with multiple normal categories including both “handlebar” and “stem.” In one embodiment, the integrated stem and handlebar 210 is further classified in an aerobar component category. In operation, if a list of all handlebars is generated by computer from the database, the integrated stem and handlebar 210 will be selected because one normal component category included in the record includes “handlebar.” Likewise, if a list of all stems is generated by computer from the database, the integrated stem and handlebar 210 will be selected because one normal component category included in the record includes “stem.” Likewise, if a list of all aerobars is generated by computer from the database, the integrated stem and handlebar 210 will be selected because one normal component category included in the record includes “aerobar.”

Another example is shown in FIG. 5. An integrated lever 240 is shown including both a brake lever 242 and a shift lever 244. In one embodiment, the integrated lever 240 is recorded in the database using a single record with a complex category, and multiple normal categories under “brake lever” and “shift lever.” One advantage of recording multiple normal categories within a single record is that data entry of new components as they emerge into the market is simplified. Multiple category information need only be entered once in the single record of the component, in contrast to multiple entries into multiple substitution tables.

In one embodiment a “set” category is included in a database record. In one embodiment, a “set” category describes multiple components that are sold together. In one embodiment, the set category includes a number of sub-categories for each of the multiple components within the single set category. One example of a set category includes a drivetrain conversion kit. Another example of a set category includes a hub set. In one embodiment, a set category operates similar to complex categories as described above. Sub-categories are similar to normal categories, while the set category is similar to the complex category.

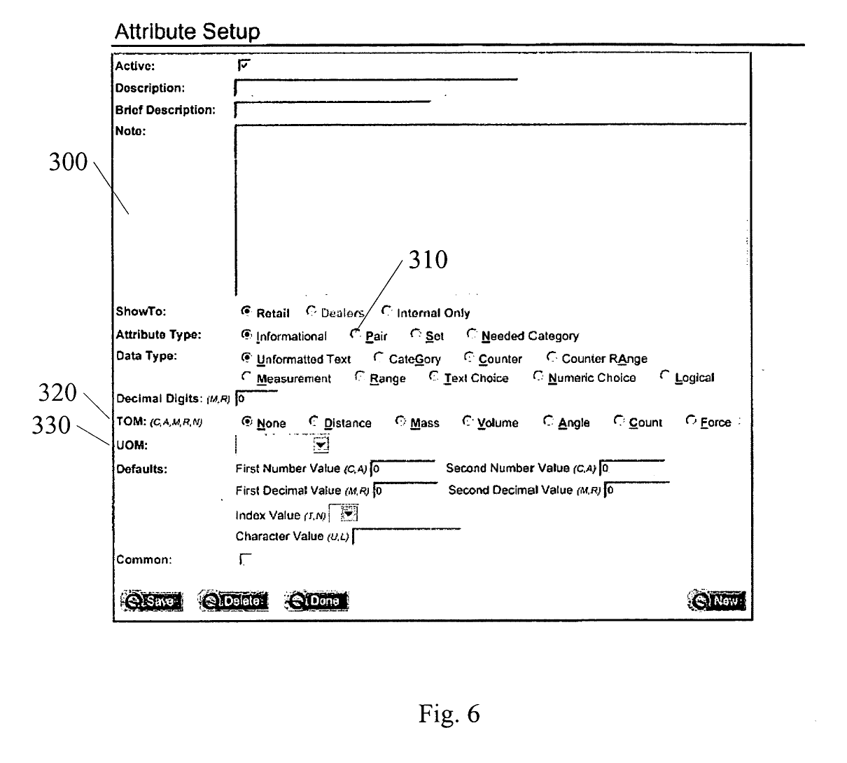

As illustrated in FIGS. 1A and 1B, in one embodiment, one or more attributes are entered into a database record for a component, in addition to component category data. In one embodiment, types of attributes include, but are not limited to informational attributes, pair attributes, set attributes, and category attributes. FIG. 6 illustrates an example user interface for entering an attribute into a database record. In one embodiment an informational attribute includes a component color or other similar attribute that does not define a compatibility relationship with another component.

In one embodiment a pair attribute indicates one half of a paired compatibility relationship. In one embodiment, a pair attribute includes a direct interface such as a diameter of a stem mating with a diameter of a fork. In one embodiment, a pair attribute includes a compatibility relationship such as a number of spoke holes in a hub being matched with a number of spoke holes in a rim.

In one embodiment, a pair attribute includes a compatibility relationship within a range. For example, a frame that is designed for a suspension fork having 80 millimeters of travel is compatible with a suspension fork having adjustable travel between 80 millimeters of travel and 125 millimeters of travel. In another example, a frame that is designed for a suspension fork having 100-130 millimeters of travel is also compatible with a suspension fork having adjustable travel between 80 millimeters of travel and 125 millimeters of travel.

In one embodiment different sides of the paired attribute are specifically assigned to each component in the pair. For example, the integrated stem and handlebar 210 from FIG. 2 has an attachment portion 212 that only accepts a given diameter. In one embodiment, an attribute is therefore entered in the database record for the integrated stem and handlebar 210 to indicate what the integrated stem and handlebar 210 “needs.” In one embodiment, a corresponding component such as a threadless fork “has” a given diameter. An attribute is therefore entered in the database record for threadless fork to indicate not only the diameter, but the concept of which side of the pair the fork belongs to. Stated another way, one component needs an attribute, the other component has the attribute. In one embodiment the recording of assigned sides of a pair interface has certain advantages. One advantage includes the ability to search the database for only the other half of the pair.

In one embodiment, a pair attribute is used to describe an adapter component. FIG. 3 shows a stem adapter 220 used to convert a quill type stem to a threadless type stem. The stem adapter 220 includes a first diameter 222 for mating with a threadless stem, and a second diameter 224 for mating inside a threaded fork. In one embodiment, a pair of attributes is stored in a database record for stem adapter 220. In one embodiment, a first attribute includes an inner diameter of a fork that dimension 224 needs to be inserted into. In one embodiment, another attribute includes the first diameter 222 that the stem adapter 220 has. Other adapters include seatpost or handlebar shims with both an inner and an outer diameter.

Yet another example of a pair attribute component is shown in FIG. 4 that does not use numeric values. A brake adapter 230 is shown in FIG. 4, including a cable input end 232 and a cable output end 236. The brake adapter 230 is used to adapt a short travel brake lever to a long travel brake caliper. The input end 232 leads to a large diameter portion 238 while the output end 236 leads to a small diameter portion 234. In one embodiment, at least one pair attribute is included with a database record for the brake adapter 230. In one attribute example, the input end 232 needs a short travel brake lever and the output end needs a long travel brake caliper.

In the examples used above, one side of the pair is designated to have an attribute, while the other side of the pair is designated to need the attribute. While particular sides of the “have” and “need” interface are described above, one of ordinary skill in the art having the benefit of the present disclosure will recognize that in many circumstances the assignment of “have” or “need” can be reversed. Further, the terms “have” and “need” are used for convenience in describing a paired relationship. Other one to one descriptions such as “male” and “female” etc. could also be used to describe a paired relationship. Additionally, although one or two attributes are shown in the examples above, the invention is not so limited. Single components and their respective single database records can include any number of individual attributes within the single record. This greatly increases the flexibility and functionality of the database system. In one embodiment, multiple attributes includes more than one type of attribute such as informational attributes, pair attributes, set attributes, or needed category attributes.

In one embodiment, a type of measure is selected to further characterize an attribute. FIG. 6 shows one example of a number of types of measure selectable from a number of choices in a user interface 320. Examples of types of measure include, but are not limited to distance, mass, volume, angle, count and force. One advantage of further characterizing an attribute using types of measure includes more specific searching ability. For example, 32 millimeters will not be confused with 32 spoke holes in a wheel. Another advantage of further characterizing an attribute using types of measures includes the ability of unit conversions between units of measure within the same type of measure, such as is necessary since some parts are naturally weighed in grams and some parts are naturally weighed in pounds.

Examples of attributes that can be further characterized by types of measure includes diameters, weight of a component, volume of a water bottle, angle of rise of a stem, pressure rating of a tire, etc. In one embodiment, units of measure further characterize selected types of measure. FIG. 6 shows one example of units of measure selectable in a user interface 330.

In one embodiment, an attribute is further characterized by choosing either: what the component is; what the component is compatible with; or what the component is not compatible with. Using the drivetrain example above, in one embodiment a chain includes a “10-speed drivetrain” attribute where the chain is 10-speed, and that is all that it is. In another example, a chain can be 7, 8, or 9 speed compatible, and also not compatible with a 10-speed cassette. Although a chain and drivetrain is used as an example, the invention is not so limited.

In one embodiment, a set attribute defines an interface between components that are not necessarily mated one to one. In one example, a steer tube on a threadless fork has a set attribute of a one inch diameter. A threadless stem, and one or more steer tube shims have a set attribute that needs a 1 inch steer tube diameter. In one embodiment, it is useful to define the steer tube interface as a set attribute, in contrast to a pair, because the number of interfacing components is variable. Because, in this example, one, two, three, etc. steer tube shims are possible, a paired interface between each shim and the steer tube may not be desirable. A set attribute defines the compatibility at the interface, but does not require that each corresponding component be paired specifically to the mating component. Another example includes drivetrain elements such as a chain, derailleur, cassette, etc. Although all elements need to be compatible (such as 10-speed compatible) they do not necessarily have to be paired in a one to one relationship. In one embodiment, a set attribute, in contrast to a pair attribute, is used to describe this situation.

In one embodiment a “category” attribute is included in a database record. In one embodiment, a category attribute describes what a component is or includes. In one embodiment, a category attribute describes a component that is needed. Stated another way, similar to other attributes described above, in one embodiment, a category attribute can be either side of a has/needs relationship. In one embodiment, a category attribute can be used to express multiple categories, similar to a complex or set category as described above. For example, if a frame comes with a seatpost included, in one embodiment, a set category is created including normal categories of a frame and a seatpost. In another embodiment, the frame is recorded using a single normal frame category, and a category attribute is added that indicates the frame “has” a seatpost. In this option, the category nature of the seatpost is expressed as an attribute of the frame.

In one embodiment, a high level record is created to track a number of components that are needed. Some examples of high level records include, but are not limited to, complete bikes; component kits, component groups, etc. In one example, a record for a crank component includes a “category” attribute that states that the component is a crank. A high level record for a bike needs a crank before it is complete, therefore the record for the complete bike would include a “category” attribute that states the need for a crank. As components are selected (such as the crank in the previous example) the records for the complete bike and crank are changed to reflect that the crank record's attribute (‘has’ a crank) has been paired to the complete bike record's attribute (‘needs’ a crank). In this way, the software keeps track of when the bike or other high level record is complete.

In one embodiment attributes are included in a record as an expression. In one embodiment, the expression includes one of a number of forms. One possible form includes a simple expression such as frame color. A frame record would include an expression where the attribute “frame color” is equal to “red” for example. An example expression would be: frame color=red. Another possible expression would include multiple clauses such as a clause for “front,” and a clause for “brake” indicating that a bike needs a single part that is both “front” and “brake.” Another possible expression would be a logical expression such as an “if—then” statement. An example of a logical expression includes a frame that needs a certain length bottom bracket spindle if a particular brand of crank is selected. In one embodiment, a negative logical expression is included in an expression, such as if not X, then Y. In one embodiment, a logical expression is stored in a complete bike record.

In one embodiment a hierarchy of enforcement rules are also associated with selected attributes. In one embodiment, a “describe” enforcement is used when the attribute must not be matched with an incompatible component, but it may be left unmatched. In one embodiment, a “require” enforcement is used when the attribute must be matched with a compatible component, and it may not be left unmatched. In one embodiment, a “suggestion” enforcement is used to provide a user who selects one component with some guidance as to a possible additional component.

An example of a describe enforcement of an attribute includes a handlebar with an aerobar clamp diameter of 26.0 mm. The aerobar clamp diameter on the handlebar needs to correspond to a mating aerobar, however the mating of an aerobar to a bike is not a necessity. An aerobar component, on the other hand, if included, must be mated to a handlebar. In this example, the handlebar includes an attribute that “describes” a 26.0 clamp diameter, while the aerobar has a 26.0 clamp diameter that “requires” a 26.0 clamp diameter. In one example a suggestion informational attribute includes a large size frame where the frame database record includes a suggestion for a long stem.

In one embodiment component categories also include enforcement rules. In one embodiment, component categories include enforcement rules when the category is represented as an attribute as discussed above. In one embodiment, a component is enforced as “optional.” In one embodiment, a component is enforced as “required.” In one embodiment, a component is enforced as “suggested.” One example of an optional component includes pedals. Many new bike purchasers buy bikes without pedals because they already have a pair that they can transfer to the new bike. One example of a required component includes a chain. One example of a suggested component includes a water bottle cage.

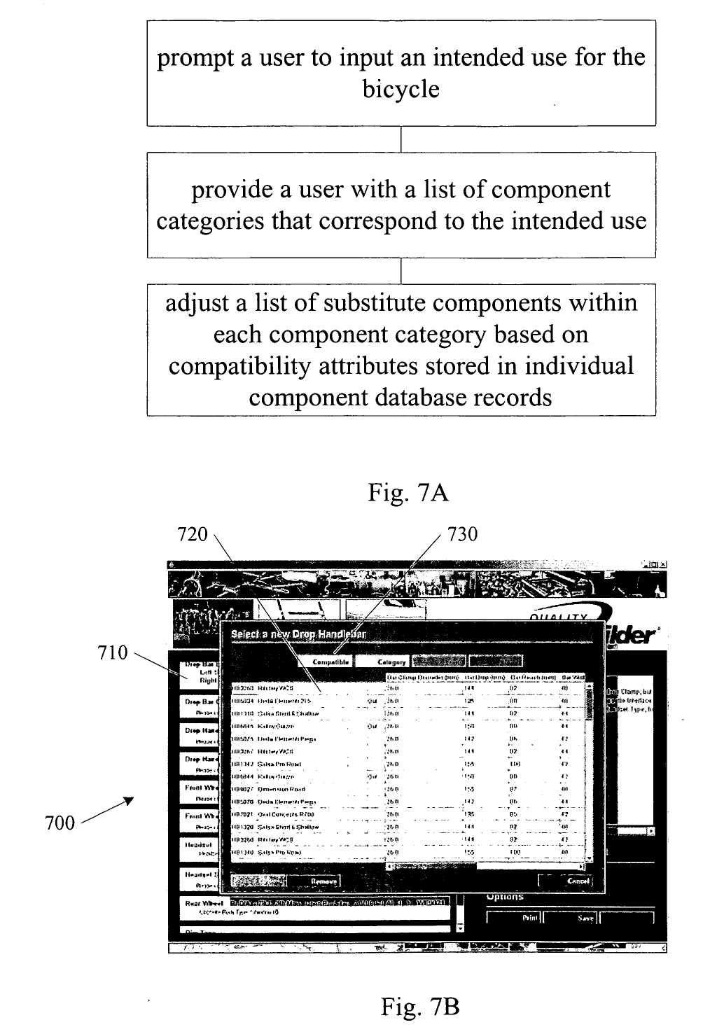

FIG. 7A shows one embodiment of a flow diagram in selecting components to build a bike or a portion of a bike. In one embodiment selected database record configurations as described above are used in selecting components to build a bike or a portion of a bike. As shown in the flow diagram, software is used with a computer device to prompt a user for a bicycle intended use. In one embodiment, examples of an intended use includes a selection such as a road bike, a mountain bike, a single speed bike, conversion kit, etc. in one embodiment, further high level prompts are submitted to the user such as component brand and component group.

In one embodiment, based on the user selection of an intended use and/or other high level prompts, a list of component categories is generated. In one embodiment, the list of component categories will result in a complete bike, or sub-assembly as requested by the intended use. In one embodiment, each component category in the list of component categories is adapted to generate a list of compatible components that may be substituted for the current selection.

FIG. 7B shows one example of a user interface 700 where a list of component categories 710 is shown. Within one of the component categories, a list of substitute components 720 is shown. FIG. 7B further shows a compatibility button 730 that reduces the list of substitute components 720 to only compatible components.

In one embodiment, complex category components such as integrated bars/stems, or integrated brake/shifters are provided as substitution options based on at least one of the normal categories that are stored in the individual records.

In one embodiment, as components are selected or changed for individual categories, the available options in other lists of compatible components are adjusted based on information stored in each component record. In one embodiment, attribute data is used to adjust available options in each list. As discussed above, several possible attributes are available to determine compatibility with other components. In one embodiment, the lists are adjusted based on compatibility.

In one embodiment, if a component is selected that affects compatibility with other components, the other components are automatically changed to maintain compatibility. In one embodiment, a user is prompted to re-select previously chosen components to maintain compatibility. An example includes a handlebar that is selected after a stem has already been selected, where the handlebar clamp diameter does not match the stem clamp diameter. In one embodiment, a new stem with a similar brand/model is automatically selected to match the clamp diameter interface. In one embodiment a user is offered a choice of an adapter to provide the compatibility such as a shim between the handlebar and the stem example.

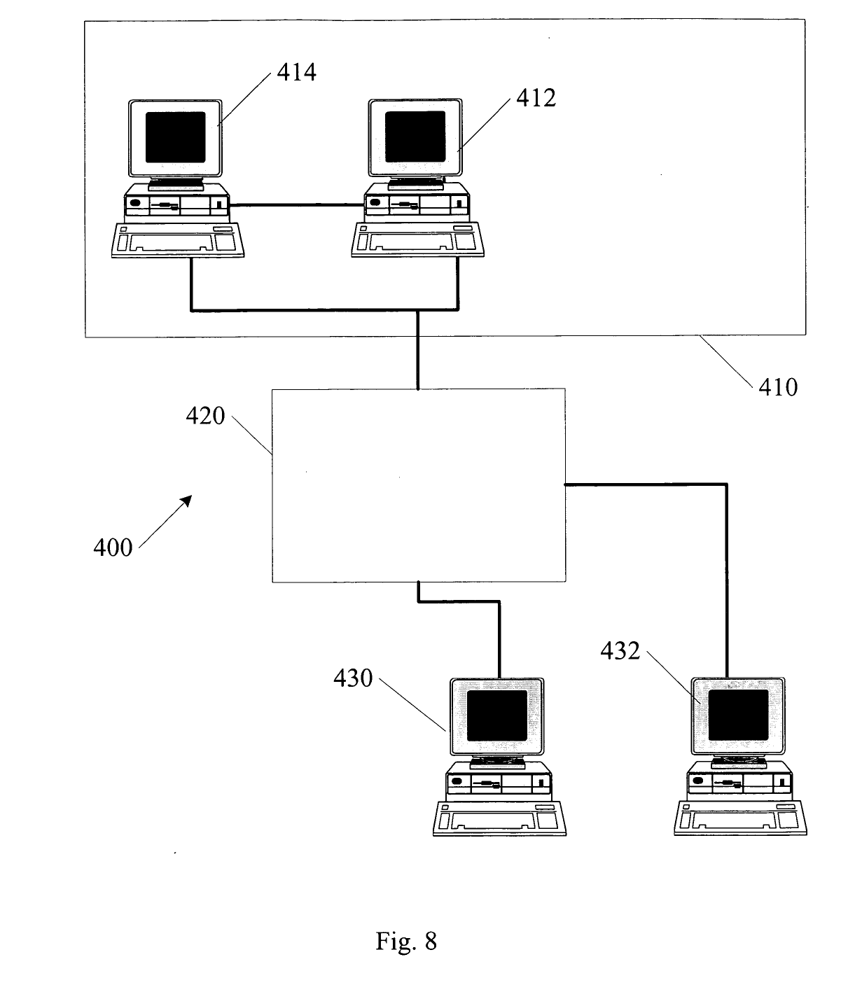

FIG. 8 shows an example of an environment 400 where methods or software as described above is used. A provider site 410 is shown with a network that includes a number of computers or servers. A first computer 412 and a second computer 414 is shown. In one embodiment the computers or servers are networked together in a local area network. In one embodiment, a user on the first computer 412 can access software on the second computer 414 to enter database records. In one embodiment, a user on the first computer 412 can access software on the second computer 414 to build a bike according to embodiments described above.

FIG. 8 further shows a third computer 430 and a fourth computer 432 that have access to the provider site 410 through a network 420 such as the internet. In one embodiment, a client such as a bike shop can access the provider site 410 and access software on the second computer 414 to build a bike according to embodiments described above. In one embodiment, an individual consumer using a home computer and internet connection can access software on the second computer 414 to build a bike according to embodiments described above. In one embodiment, although the invention is not so limited, software includes JAVA software that is delivered to and run locally on client computers.

### CONCLUSION

Using embodiments described above, a number of advantages are realized. One advantage of methods and database software described above includes component characteristics, compatibility attributes, and optionally multiple functionality of components in a single component database record. Another advantage of methods and database software described above includes dynamic adjustability of component substitution lists as other components are selected. Another advantage of methods and database software described above includes simplification of data entry as new products are added to the database. Substitution tables are not used.

Although selected advantages are detailed above, the list is not intended to be exhaustive. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. A method of classifying bicycle components, comprising:
creating a record for individual components in a database, including:
creating a first record in a database for a first bicycle component; and
creating a second record in a database for a second bicycle component;
identifying an attribute necessary for compatibility of the first bicycle component with the second bicycle component;
storing data in the first record indicating a first side of the attribute relationship of the first bicycle component; and
storing data in the second record indicating a second side of the attribute relationship of the second bicycle component.

2. The method of claim 1, further including storing data indicating at least one category for each component in each record.

3. The method of claim 1, further including storing data indicating a type of measure associated with the attribute.

4. The method of claim 3, wherein the type of measure is chosen from a group consisting of distance, mass, volume, angle, count and force.

5. The method of claim 1, wherein identifying the attribute includes identifying an attribute that defines a component interface dimension.

6. The method of claim 1, wherein the first bicycle component and the second bicycle component are exclusively paired in a one to one relationship.

7. The method of claim 1, wherein the first bicycle component and the second bicycle component are non-exclusively compatible.

8. The method of claim 1, further including creating an adapter record for an adapter component designed to make two previously incompatible components work with each other, including:
storing data in the adapter record indicating a compatible relationship with each of the two previously incompatible components.

9. The method of claim 1, wherein identifying the attribute includes identifying an attribute including a range of compatibility values.

10. The method of claim 1, further including storing data in a record indicating a component associated with the record is conditionally compatible with other defined components.

11. A method of classifying a bicycle component, comprising:
creating a single record in a database for a single bicycle component that functions as both a first bicycle component and a second bicycle component;
entering a first category into the single record that the first bicycle component is a member of; and
entering a second category into the single record that the second bicycle component is a member of.

12. The method of claim 1 1, further including:
identifying an attribute necessary for compatibility of the single bicycle component with an adjacent bicycle component;
storing data in the single record indicating the single bicycle component as having the attribute; and
storing data in an adjacent component record indicating the adjacent component as needing the attribute.

13. The method of claim 1 1, further including identifying an attribute necessary for compatibility of the single bicycle component with an adjacent bicycle component;
storing data in the single record indicating the single bicycle component as needing the attribute; and
storing data in an adjacent component record indicating the adjacent component as having the attribute.

14. A method of classifying bicycle components, comprising:
creating a single record in a database representing multiple bicycle components;
entering a first category into the single record that a first bicycle component is a member of; and
representing a second category in the single record that a second bicycle component is a member of, the second category being represented as an attribute that the single record has.

15. A method of selecting components for a bicycle, comprising:
prompting a user to input an intended use for the bicycle;
providing a user with a list of component categories that correspond to the intended use, wherein lists of components in each component category are provided; and
adjusting the selection of components in each component category based on compatibility attributes that are stored in database records for individual components.

16. The method of claim 15, wherein a selected component from each component category is designed to result in a complete bicycle.

17. The method of claim 15, wherein adjusting the selection of components in each list based on compatibility attributes of components includes adjusting based on component interface attributes.

18. The method of claim 15, wherein adjusting the selection of components in each list based on compatibility attributes of components includes adjusting based on compatibility within a numeric range.

19. The method of claim 15, further including adjusting the selection of components in each list based on multiple functionality of a single selected component that takes the place of two or more other components.

20. The method of claim 15, further including automatically changing previously selected components to maintain compatibility with a current component selection.

21. A machine-readable medium with instructions stored thereon, the instructions when executed operable to cause:
a prompt to a user to input an intended use for the bicycle;
generation of a list of component categories that correspond to the intended use, wherein lists of components in each component category are provided; and
adjustment of the selection of components in each component category based on compatibility attributes that are stored in database records for individual components.

22. The method of claim 21, wherein at least one compatibility attribute between components is exclusively paired in a one to one relationship having a first relationship side and a second relationship side.
